(19) United States
(12) Patent Application Publication
(10) Pub. No.: US 2013/0246297 A1
(43) Pub. Date: Sep. 19, 2013

(54) Bid-Based Charitable Impact Statement

(71) Applicants: Raymond J. Gary, JR., Dallas, TX (US); Steven Kravit, Plano, TX (US)

(72) Inventors: Raymond J. Gary, JR., Dallas, TX (US); Steven Kravit, Plano, TX (US)

(73) Assignee: IDONATE LIQUIDATION, LLC, Dallas, TX (US)

(21) Appl. No.: 13/874,792

(22) Filed: May 1, 2013

(51) Int. Cl. G06Q 30/02

(52) U.S. Cl. CPC G06Q 30/0279
USPC 705/329

(57) ABSTRACT

A system and method of providing, at the time of the donation, the direct benefits derived from an asset donation. The asset is electronically bid instantaneously after the donor enters the asset's specific description. The bid amount is then compared with the stored cost, or impact metric, of a particular benefit.

### BACKGROUND

### Field of Invention

The invention related to the system and method of dynamically providing a donor statement of the exact impact of an asset donation.

### BACKGROUND OF THE INVENTION

The present invention is a useful and novel method for evaluating the effect of an asset donation on the community it is meant to serve.

Before discussing the direct historic prior art of impact statements, it is important to understand the various uses of the term “impact” in charitable prior art. Impact statements are distinctly used in developing philanthropic strategy, preparing audits, evaluating impact on donor, and the tactical evaluation of a proposed donation.

Philanthropic impact, or high impact philanthropy, is a planning methodology that first defines the donor's vision of how their funds will change the world. The planning then moves to maximizing the social good based on the vision statement. The donors are subsequently directed to organizations responsible for executing the steps necessary to bring the changes desired. Philanthropic impact is distinct in there is not an attempt to evaluate dollar-to-dollar outcomes or determine the success of the strategy.

Impact statements are also used in audit systems attempting to evaluate direct and indirect effects of donations previously committed and fully utilized. The audit systems may measure direct results (200,000 shoes delivered) and indirect effects (resulting in a 15% rise in middle school attendance). For instance, the U.S. Pat. No. 7,212,992 tracks the flow of donations as it moves through a network until the funds are exhausted. Each donation is assigned an index to allow the data to be tracked through a donation pipeline. The resulting impact statement is a notification, after donation, of where the donation is distributed and the good delivered.

The next category of impact statement uses an evaluation of the net effect to the donor instead of the charity. U.S. Pat. App. No. 2002/0133436 demonstrates a typical configuration of donor impact statements. The application prompts the user to input donations and the system returns the net impact of the donation over each taxation period. It is also found in the prior art the statement can be forward looking to allow the donor to gauge the value of a proposed donation.

### Tactical Evaluation

The third distinct use of impact statements is tactical evaluations of an anticipated donation by presenting potential result(s) of the donation. This group of prior art relates more closely with the present invention.

While the promise of specific deliverable for a specific donation is as old as charity, the broad use of impact statements began with the television commercials of the Christian Children's Fund that used celebrity Sally Struthers claiming “for seventy cents a day, you can feed a child like . . . ” The call to action of the commercial focused on the relatively inconsequential sacrifice of say giving up a soda to provide a day's nourishment for a child. The effectiveness of the message on culture was demonstrably catalyzed by parodies of the commercials still produced today. These early impact statements tended to focus on the impact metric portion of the calculation (“seventy cents a day . . . ”) instead of the total impact of the full donation (“feed a child for a year . . . ”).

The second type of tactical valuation of an impact statement is used today in organizations such as the United Way. The system asks the user to enter an anticipated monetary donation and then employs a back-of-the-napkin calculation to estimate the various potential impacts a donation could benefit if later employed in such manner. For instance, if a sum of five thousand dollars ($5,000.00) is entered into a United Way Impact Calculator, the system returns a list of alternative choice the institution could make:
provides 33 children in need with shoes and clothing for a school year, or
provides 20 days of respite for caregivers of a disabled family member, or
provides 16 months of after-school tutoring for at-risk children, or
provides 12 families with emergency assistance after a disaster such as a fire, or
provides 10 months of food to help families in crisis, or
provides 6 substance abuse prevention programs to schools, or
provides 5 months' stay for mothers and their children in a domestic violence shelter, or
provides 5 transitional apartments for homeless families, including utilities and budget classes, or
provides 5 job skills and training courses to help 10 people gain full-time employment, or
provides 3 families with the necessary information, assistance, and counseling to prevent foreclosure on their home, or
provides 2 summer programs for children with hearing impairments to learn critical communication and social skills, or
provides 1 parents of children with autism given specialized intervention, training and education

The third tactical valuation of an impact statement uses an asset classification system. Currently used at the Goodwill, and claimed in their U.S. Pat. App. No. 2012/0078644, the system generalizes the value of an entire class of assets into a single generalized valuation number and then divides a pre-determine impact metric into the generalized valuation. The formula being:

generalized valuation of item=impact metric

For instance, if a user selects “working computer” in the Goodwill system, then selects “1,” the impact statement will be “5.7 Hours of Job Search Classes” whether or not the item is 1983 Compaq Luggable or a 2013 MacBook Pro. Notably, the system fails to address true impact and the donation could have considerably more or less impact. This asset classification system is notably less effective than the back-of-the-napkin calculation used in the monetary donation system. There is an implicit promise that lacks credibility. To improve this slightly, and claimed in U.S. Pat. App. No. 2012/0078644, the system may ask for the condition of the item in addition to the count. As an example, having a 1983 Compaq Luggable in excellent condition may not improve the value.

All the impact statements heretofore known suffer from a number of disadvantages:

Monetary data entry. The most common of all systems, the solution asks for the dollar value of the donation to calculate the impact. If the item is an asset, the donor would have to personally estimate the monetary value of the asset a liquidator might be willing to pay.

Lack of true impact for asset donations. The impact metrics are standardized across a classification of assets so that the system can only guess at the impact a donation might have. This results in an implied promise the charity is likely unable to honor.

### SUMMARY OF THE INVENTION

An invention, which meets the needs stated above, is a system and method to provide a donor with a dynamic impact statement reflecting the true value of an asset. Information on the item specifics is collected in a variety of ways including hierarchal drop down menus, typed descriptions and barcodes. The item description is then electronically matched against one or more liquidator's item files. The donor system selects the highest bid and using an impact metric determines the amount of social good the asset will provide an organization.

### Objects and Advantages

Accordingly, besides the objects and advantages of the system for impact statement described above, several objects and advantages of the present invention are:
a) to provide an impact statement based on a specific item description;
b) to provide an impact statement immediately after entry of the asset description;
c) to provide accurate impact statements based on a bid on an asset;
d) to provide dynamic asset pricing of bids;
e) to provide accurate impact statements using an item description;
f) to provide the best bid from multiple liquidators to maximize the donation impact;
g) to provide a specific item description using a typed description;
h) to provide a specific item description using a series of hierarchal selections;
i) to provide a specific item description using the input of an identification code associated with a specific asset.

Further objects and advantages of this invention will become apparent from a consideration of the drawings and the ensuing description of the drawings.

### DRAWING FIGURES

The accompanying drawings, which are incorporated in and constitute a part of this specification, illustrate embodiments of the present invention and together with the description, serve to explain the principles of this invention. In the figures:

FIG. 1A.—Flow chart diagramming the data movement between the donor systems, liquidator systems, and the charity systems.

FIG. 1B.—Flow chart demonstrating various methods for entering and matching the asset description.

FIG. 2A.—Flow chart depicting the communications and asset exchanges between the donor, liquidator and charity.

FIG. 2B.—Flow chart illustrating the use of the invention when the charity acts as the intermediary between the donor and the liquidators.

FIG. 2C.—Flow chart showing the system being used with a third-party provider facilitating the communication and movement of assets between the donor, liquidator, and charity.

### KEY TERMS

Bid manager: system functioning to match description to item file, generate bid/bid amount, store bid, transmit bid, match acceptance of bid.

Impact metric: numeric figure represent the cost of a single benefit supplied by a charity.

Impact statement: calculated in real-time based on the true value of an asset, the total good generated by an asset donation.

Item File: a table, list, or database of items a buyer is willing to purchase for assets donated to a charity.

### REFERENCE NUMERALS IN DRAWINGS

10 Donor, user

20 Charity

30 Liquidator

40 Introductory message

50 Asset, asset donation

55 Asset description

56 Keyed description

57 Index, barcode, serial number

58 Drop down list

59 Voice file

60 Impact metric

65 Impact statement

70 Bid

74 Bid amount

76 Bid acceptance, accept bid

78 Bid manager

80 Shipping label

90 Funds

100 Item File

110 Donor system

120 Charity system

130 Liquidator system

140 Third-party manager

### DETAILED DESCRIPTION OF THE DRAWINGS

Referring to the drawings, in which like numerals represent like elements,

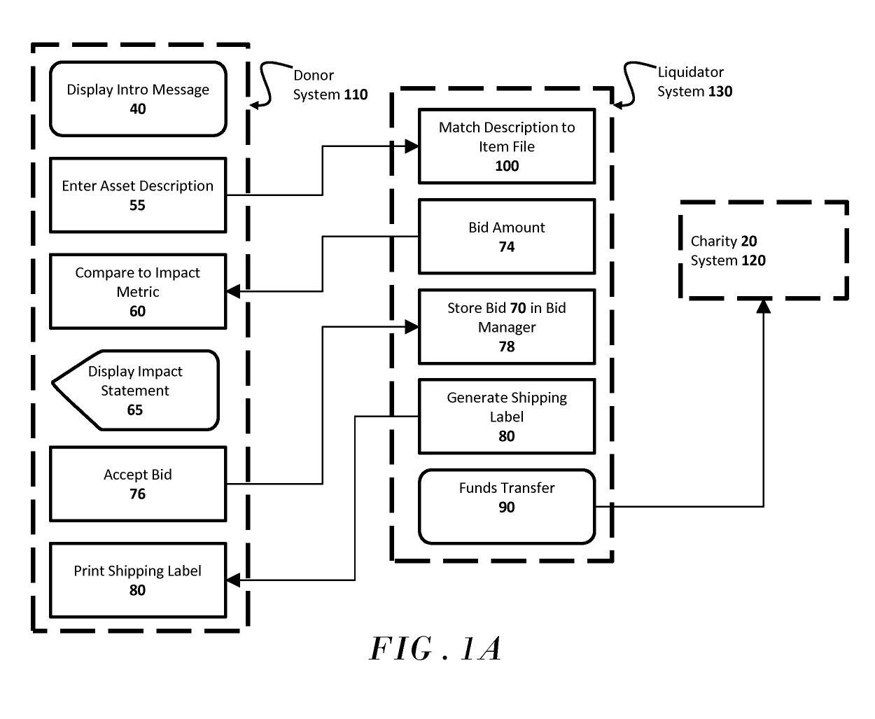

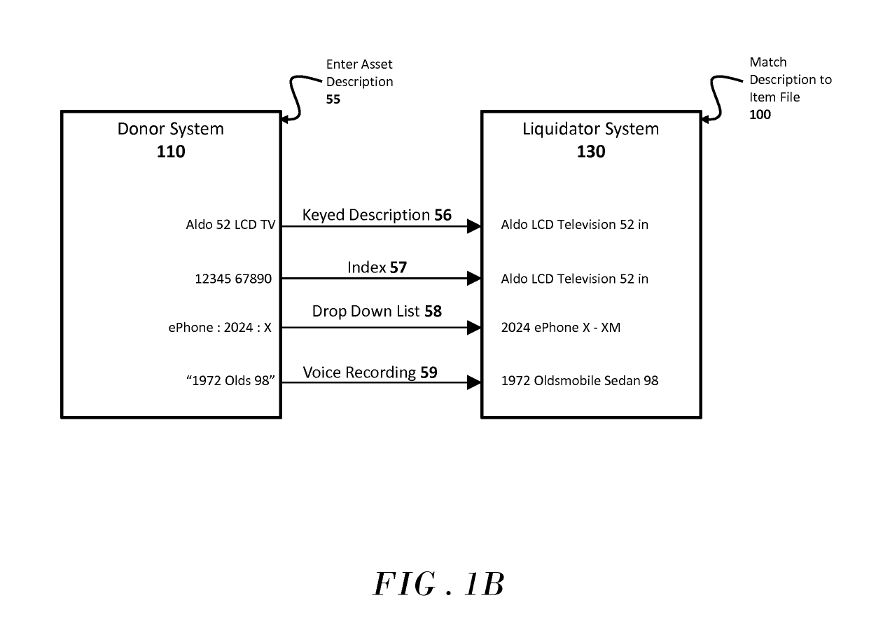

FIGS. 1A-1B

Turning to FIG. 1A, the logic flow chart depicts the flow of data and processes within and between the donor system 110, liquidator system 130 and charity system 120.

The present invention uses a computer-implemented interactive system communicating and processing various steps across disparate systems. The process begins by soliciting charitable asset donations 50 on a donor system 110, or a third-party system 140 representing the charity 20. Typically, the web page, located on the World Wide Web, might explain the goals of charity 20; the successes of the receiving institution; the global impact; or specific impacts to individuals or groups. It is also desirable to quantitatively demonstrate how the user's 10 anticipated asset donation 50 would impact the individuals served. In order to invite the potential donor 10 to participate in the present invention, an introductory message 40 is displayed inviting participation. The message 40 would alternatively or collectively explain the outcome of the donation 50, display images showing the resulting impact statement 65, basic instructions to complete the form, pop-up detailed help, audio files, and/or video files.

Following the directions of the introductory message 40, the potential donor 10 enters an asset description 55 to begin the process of receiving an individualized impact statement 65. Instead of using classification or categories, the description 55 in the present invention results in a specific identification of the asset 50 to be donated.

The entering of the specific asset description 55 can be done using a number of methods further detailed in FIG. 1B. Turning briefly to FIG. 1B, in one preferred embodiment of the present invention, the user 10 enters an alphanumeric asset description 55 such “Aldo 52 LCD TV.” This may be done by either typing a description 56 into the user 10 interface, selecting a specific asset 50 from a drop down list 58, or a combination of both a keyed description 56 and a drop down list 58. For instance, a user 10 would begin typing “ALD” and be provided an instantaneous drop down list 58 of selections, such as:
Aldo 30 LED Television
Aldo 32 LCD Television
Aldo 32 LCD Monitor
Aldo 40 Monitor with Antenna
Aldo 52 LCD Television

The prospective donor 10 would then select the item from the resulting drop down list 58.

In a second preferred embodiment for selecting an asset description 55, the user 10 would supply an index 57 to the interface such as a keyed product serial number 57 or a scanned barcode 57. The resulting key may be matched against a file within the donor system 110 or simply transferred to the liquidator system 130 for resolution.

In a third preferred embodiment for selecting an asset description 55, the donor system 110 would create a voice file 59 from the donor 10. The voice file 59 may be translated to text by the operating system, translated into text by the donor system 110, or simply transmitted as a file to the liquidator system 130.

Moving left to right in FIG. 1B the potential donor 10 enters a description which is then transmitted to the liquidator system 130 to match the description 55 to an item file 100. In the example of FIG. 1B, the user 10 would type “Aldo 52 LCD TV” in the donor system 110 which would be sent to the liquidator system 130 responsible for matching the description to the item file 100 and returning a similar description “Aldo LCD Television 52 in.” In the case of entering the asset description 55 using an index 57 the consumer would key, or scan, “12345-67890” in the donor system 110 that once transmitted to liquidator system 130 and used as a key to identify the item as “Aldo LCD Television 52 in.” In the third example, a user 10 selects “ePhone” from a drop down list 58, then selects “2024” model and “X” submodel designation. This may be done within a single drop down list 58 or multiple hierarchical drop down lists 58. The resulting description of “ePhone:2024:X” is then transmitted to the liquidator system 130 to match the description against the item file 100 resulting in the description of “2024 ePhone X-XM.” A final example would record the user's 10 voice into a voice recording file 59 within the donor system 110 and transmit either the translated text or the voice file 59 itself to liquidator system 130. The resulting voice is matched to the item file 100 as “1972 Oldsmobile Sedan 98.”

Returning to FIG. 1A, once the description has been matched to the item file 100, the liquidator system 130 retrieves an associated bid amount 74 from the liquidator system 130. The bid amount 74 may be stored in the liquidator system 130, calculated based on an amount stored in the liquidator system 130, or retrieved from a third party and then matched to the description 55 in the liquidator system 130.

Once matched, the bid 70 comprises a transaction identifier, the asset description 55, and bid amount 74, which is stored in a bid manager 78 in the liquidator system 130.

The bid amount 74 is transmitted to the donor system 110 to prepare the impact statement 65. The bid amount 74 is compared to impact metric 60 stored on the donor system 110. The impact metric 60 is the cost of delivering a single service or product to the entity or individuals served. For instance:
1 pair of shoes: $3.19
1 day of meals: $0.78
1 semester of job training: $448.00
1 laptop with software: $249
30 days of fresh water: $12.49
1 campaign stop: $700.00

As an example of comparing the impact statement 65 to the bid amount 74, if the asset donation 50 bid amount 74 is $1,400.00, the above example impact metrics 60 would result in the impact statement 65:
439 pairs of shoes, or
1,795 days of meals, or
3 semesters of job training, or
6 laptops with software, or
9 years, and 4 months of fresh water, or
2 campaign stops.

The impact statement 65 is displayed to the perspective donor 10 to encourage the asset donation 50. If the donor 10 accepts the bid amount 74, the systems then begin the processes for collecting the asset 50 and distributing the funds 90 to the charity 20. To accept the bid amount 74, the donor 10 may not be shown the actual bid amount 74. Instead, the donor 10 may accept, or approve, the impact statement 65. The system may allow the donor 10 to select from multiple impact statements 65 or to choose from only a single impact statement 65. The result is the donor system 110 transmits the bid acceptance 76 to the bid manager 78 in the liquidator system 130. In response to the bid acceptance 76, the liquidator system 130 generates a shipping label 80. In the most preferred embodiment, the shipping label 80 may then be transmitted to the donor system 110 for printing by the donor 10. The system may also allow the shipping label 80 to be emailed to the donor 10 or printed and then shipped to the donor 10. The shipping label 80 may comprise packing and shipping materials to assist in the efficient donation of the asset 50. In another embodiment, the generated shipping label 80 may also be emailed or shipped by the liquidator system 130.

In the last branch of FIG. 1A, the liquidator 30 transfers funds 90 to the charity system 120. As used herein, the charity system 120 may comprise a server managed by the charity 20, a server managed by third-party 140 on behalf of the charity 20, a banking institution to receive the funds 90, or a third-party to convert the funds 90 into the promised impact. Funds 90 comprises cash, cash equivalents, points, promises, and/or goods.

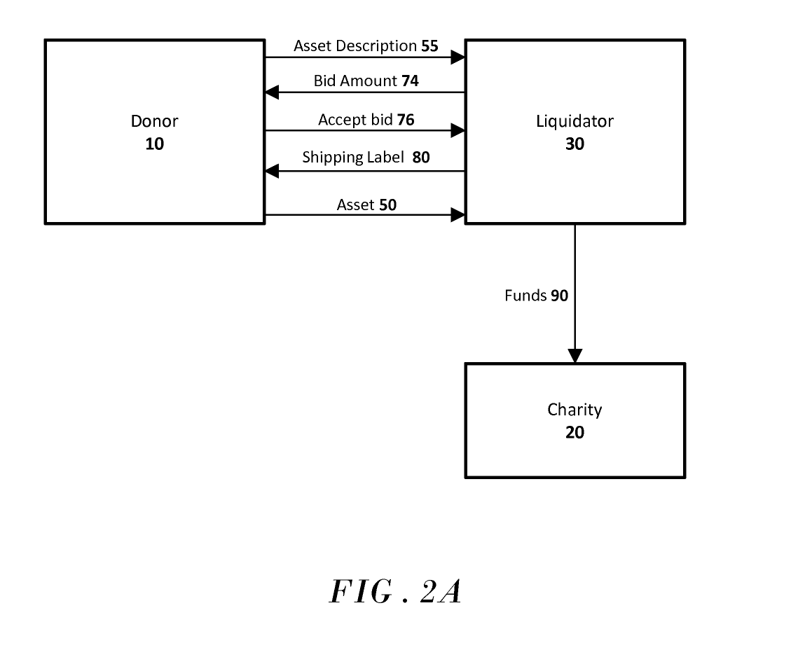

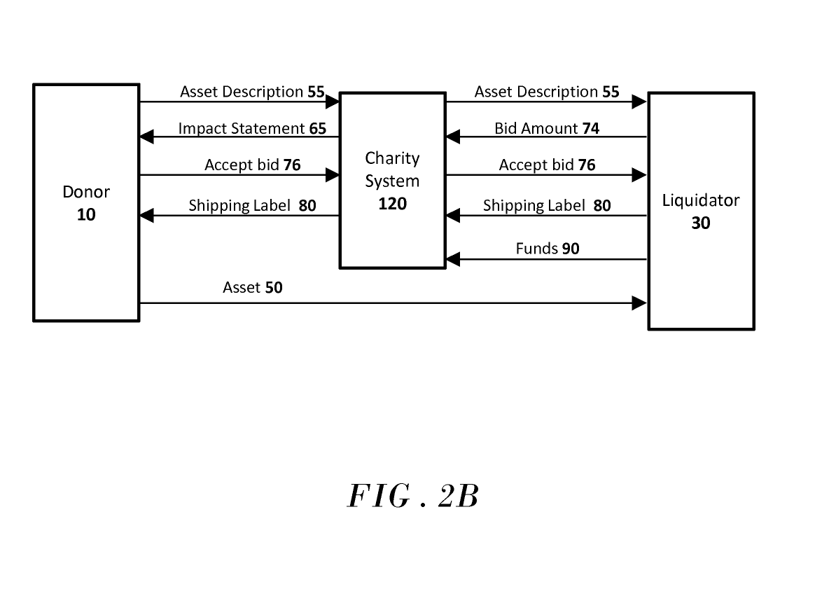

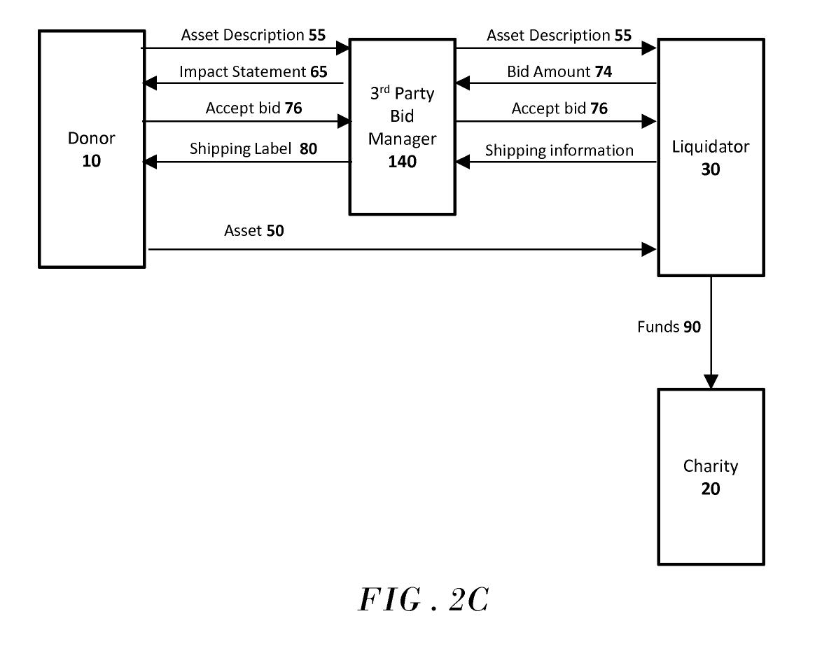

FIG. 2A

Referring now to FIG. 2A, the flow chart demonstrates the exchange of data and assets 50 between the donor 10, liquidator 30, and charity 20. Before examining the role for the manager of the consumer-facing donor system 110, it is helpful to understand the fundamental exchanges of data and assets 50. The flow in FIG. 2A remains consistent throughout the various embodiments of the invention.

The process begins by the donor 10 supplying a description of the asset 55. The description 55 must be detailed enough for a liquidator 30 to provide a committed bid amount 74. The description 55 comprises a manually typed description 56; an index 57 such as a serial number 57 or scanned barcode 57; a drop down list 58; a voice file 59; or any combination of these asset description 55 methods.

Donor 10, as used herein, comprises any individual, business, organization, entity, computer system and/or the like attempting to donate assets 50 to another individual, charity 20, political campaign, business, organization, entity, or computer system. Charity 20, as used herein, comprises any individual, non-profit, for-profit, business, organization, political campaign, lobbyist, entity, computer system and/or the like.

The liquidator 30 must then convert the asset description 55 into a bid amount 74 and transmit the bid 70 to the donor system 110. The bid 70 amount is presented to the donor 10 as an impact statement 65. The donor 10 must then accept the bid 76 by approving the impact statement 65. When the liquidator 30 receives the accepted bid 76, the liquidator 30 then provides shipping instructions which comprises a shipping label 80. The shipping label 80 comprises a transaction identification, asset 50 to be shipped, the name and address of the shipper, name and destination for the asset 50 to be shipped, payment consideration for the shipping costs, and information about the impact 65 of the asset donation 50.

Liquidator 30, as used herein, comprises any individuals, businesses, entities, organizations, financial institutions, computer systems, or any such combination, capable of providing an online bid 70 and transferring funds 90.

The donor 10 would then have the final responsibility of conveying the asset 50 to the destination selected by the liquidator 30.

At any time after the bid is accepted 76 the liquidator 30 would provide funds 90 comprising some portion of the bid amount 74 to the charity 20.

FIG. 2B-2C

FIG. 2B is a flow chart diagramming the charity 20 acting as the facilitator of the relationship between the donor 10 and the liquidator 30. The charity system 120 receives the asset description 55 from the donor 10 and relays to the liquidator 30 to enable the liquidator system 130 to generate a bid 70, including a bid amount 74. The bid amount 74 is displayed to the donor 10 as an impact statement 65. The donor 10 then accepts the bid 76 by approving the impact statement 65 which is then transmitted to the liquidator 30 by the charity system 120. The liquidator 30 transmits the shipping information comprising a shipping label 80 to the charity system 120. The charity 20 may then electronically display the shipping label 80 in the donor 10 browser, email, or mail with additional shipping materials.

The donor's 10 final responsibility in the transaction is sending the asset 50 to the destination designated by the liquidator 30 on the shipping label 80. Anytime after the liquidator 30 receives the bid acceptance 76, the liquidator 30 would forward all or a portion of the bid amount 74, as funds 90, to the charity 20.

Finally, turning to FIG. 2C demonstrating the use of the invention when a third-party 140 manages the communications, facilitates asset 50 exchange and fund 90 transfer between the donor 10, charity 20 and liquidator 30. In contrast to FIG. 2B, the third-party manager 140 acts a representative for the charity 20 and may give the appearance to the user 10 that the donor 10 is interacting with the charity 20 directly. The third-party manager 140 may also appear to the donor 10 as representing a group of charities 20 and displaying the impact from multiple charities in the impact statement 65.

The donor 10 electronically supplies an asset description 55 to the third-party 140 system which is electronically relayed to the liquidator 30. The liquidator 30 matches the asset description 55 and generates a bid 70 which comprises a bid amount 74. The third-party 140 system then compares the bid amount 74 to the impact metric 60 and generates an impact statement 65 to display to the donor 10. The donor 10 accepts the impact statement 65 which generates a bid acceptance 76 to the liquidator 30 via the third-party manager 140.

The liquidator 30 may then communicate to the third-party 140 system shipping information to facilitate the third-party manager 140 to generate a shipping label 80 for the donor 10. The donor 10 ships the asset 50 to the location designated by the liquidator 30. The charity's 20 role is to receive the funds 90 from the liquidator 30.

Benefits, other advantages, and solutions to problems have been described herein with regard to specific embodiments. However, the advantages, associated benefits, specific solutions to problems, and any element(s) that may cause any benefit, advantage, or solution to occur or become more pronounced are not to be construed as critical, required, or essential features or elements of any or all the claims of the invention. As used herein, the terms “comprises”, “comprising”, or any other variation thereof, are intended to cover a non-exclusive inclusion, such that a process, method, article, or apparatus composed of a list of elements that may include other elements not expressly listed or inherent to such process, method, article, or apparatus.

### Advantages

From the description above, a number of advantages become evident for the “Bid-Based Charitable Impact Statement.” The present invention provides all new benefits for participating parties including donors, charities and liquidators:
a) allows donors to have an real-time representation of the impact of their asset donation;
b) allows donors to donate assets without first determining the asset value;
c) allows liquidators to electronically bid on donated assets;
d) allows liquidators to set bids by a single item description;
e) allows developers to use barcodes to prepare an impact statement;
f) allows charities to accept asset donations;
g) allows charities to provide a precise impact promise for asset donations;
h) allows charities to use multiple liquidator bids for a single asset to determine the highest bid price;
i) allows charities to process asset donations without handling the asset.

What is claimed is:

1. A method of charitable donation across systems, the method comprising:
a. Using a browser, displaying an introductory message on a donor system;
b. data entry of an asset description on the donor system;
c. accepting the asset description input on the donor system;
d. matching the asset description to an item file on a liquidator system;
e. retrieving a bid amount from the item file on the liquidator system;
f. storing the bid amount in a bid manager on the liquidator system;
g. transmitting the bid amount to the donor system;
h. comparing the bid amount to an impact metric on the donor system;
i. via the donor's browser, displaying an impact statement;
whereby, the donor system can accurately display the quantitative impact of a donation.

2. A method of claim 1, wherein said data entry of asset description is a keyed description.

3. A method of claim 1, wherein said data entry of asset description is an index.

4. A method of claim 1, wherein said data entry of asset description is a serial number.

5. A method of claim 1, wherein said data entry of asset description comprises inputting into the charity system with a barcode reader.

6. A method of claim 1, wherein said asset description is a drop down list.

7. A method of claim 1, wherein said item file comprises a list.

8. A method of claim 1, wherein said item file comprises a database.

9. A method of charitable donation across systems, the method comprising:
a. employing a browser, displaying an introductory message on a donor system;
b. data entry of an asset description on the donor system;
c. accepting the asset description input on the donor system;
d. matching the asset description to an item file on a liquidator system;
e. retrieving a bid amount from the item file on the liquidator system;
f. storing the bid amount in a bid manager on the liquidator system;
g. transmitting the bid amount to the donor system;
h. comparing the bid amount to an impact metric on the donor system;
i. via the donor's browser, displaying an impact statement;
j. accepting the bid on the donor system;
k. transmitting a bid acceptance to the liquidator system;
whereby, the donor system responds to a asset bid based on an impact statement.

10. A method of claim 9, wherein said data entry of asset description is a keyed description.

11. A method of claim 9, wherein said data entry of asset description is an index.

12. A method of claim 9, wherein said data entry of asset description is a serial number.

13. A method of claim 9, wherein said data entry of asset description comprises inputting into the charity system with a barcode reader.

14. A method of claim 9, wherein said item file comprises a list.

15. A method of claim 9, wherein said item file comprises a database.

16. A method of charitable donation across systems, the method comprising:
a. using a browser, displaying an introductory message on a donor system;
b. data entry of an asset description on the donor system;
c. accepting the asset description input on the donor system;
d. matching the asset description to an item file on a liquidator system;
e. retrieving a bid amount from the item file on the liquidator system;
f. storing the bid amount in a bid manager on the liquidator system;
g. transmitting the bid amount to the donor system;
h. comparing the bid amount to an impact metric on the donor system;
i. via the donor's browser, displaying an impact statement;
j. accepting the bid amount on the donor system;
k. transmitting a bid acceptance to the liquidator system;
l. transferring funds up to the bid amount to a charity system.
whereby, the liquidator system supplies funds to the charity.

17. A method of claim 16, wherein said data entry of asset description is a keyed description.

18. A method of claim 16, wherein said data entry of asset description is an index.

19. A method of claim 16, wherein said data entry of asset description is a serial number.

20. A method of claim 16, wherein said data entry of asset description comprises inputting into the charity system with a barcode reader.
